(19) United States
(12) Patent Application Publication
(10) Pub. No.: US 2017/0188696 A1
(43) Pub. Date: Jul. 6, 2017

(54) Surface Cleaning Brush

(71) Applicant: Landmann USA, Fairburn, GA (US)

(72) Inventor: Ryan Neal, Portland, OR (US)

(21) Appl. No.: 15/394,999

(22) Filed: Dec. 30, 2016

Related U.S. Application Data
(60) Provisional application No. 62/273,643, filed on Dec. 31, 2015.

(51) Int. Cl. A46B 15/00; A46B 7/04; A47J 37/07

(52) U.S. Cl. CPC A46B 15/0081; A47J 37/0786; A46B 7/046

(57) ABSTRACT

A surface cleaning brush is disclosed having a brush head with a plate, the plate having a plurality of apertures. U-Shaped bristle assemblies are inserted in the apertures and the base of the U-shaped bristle assemblies are secured with pins bent perpendicularly to the plate. The pins and bases of the bristle assemblies are then encased in a suitable hardened material to prevent their removal.

### CROSS-REFERENCE TO RELATED APPLICATION

This application claims the benefit of U.S. Provisional Application 62/273,643, filed Dec. 31, 2015, which is incorporated herein in its entirety.

### BACKGROUND

Surface cleaning brushes are used daily in a multitude of industries, practices, and environments. A common example is a brush utilized for cleaning the cooking surface of a barbecue grill. Such cleaning brushes can have a variety of shapes and sizes, be constructed from a variety of materials, and may be supplied with or without a handle. Where no handle is included, the base of the brush is normally configured with indents, slots, and like expedients to be gripped by the user. A supplied handle can be of any design, long or short, and configured such that the user can manipulate the brush head to apply the requisite pressure to effect cleaning.

Brushes used for relatively severe duty, such as cleaning a barbecue grill cooking grate, have relatively substantial, stiff, sturdy bristles. The bristles may be formed from metal, such as steel, copper, and the like, carbon fiber, hard plastic, synthetic materials, etc. The durability of the bristles is necessary to withstand the force applied to the surface to be cleaned.

One of the main disadvantages with brushes of this type is the tendency of the bristles to loosen and become dislodged during use. Where used on a cooking grate, dislodged bristles may become lodged in or otherwise incorporated in food being cooked on the grill, thus presenting a choking hazard or other type of injury.

It is to this and other disadvantages of prior art surface cleaning brushes that the present disclosure is directed.

### SUMMARY

The present brush is designed to eliminate the possibility of the bristles becoming loose or becoming disengaged from the brush. The brush also has a unique scraper at one end thereof to facilitate cleaning the cooking surface or other surface on which the brush is used.

Essentially, per the attached drawings, the bristles are U-shaped and are pressed all the way through the base block, and then legs of a staple or the like are bent at an angle to keep the bristles from pulling out under customary force. The bristles will literally break, before the bristle dislodges. The cavity surrounding the securing means will be re-injected with plastic or the like to act as a further bonding of the parts. There are other ways that bristles could be bonded, for example, with spot-welds, adhesives, and other means.

The tool hook spins 360 degrees. This functionally makes it easier to hang on a given hook/handle which is normally attached to any grill, similar to clothes hangers which have spinning hooks. This makes the brush easier to hang on any hook/rod, because one doesn't have to first locate an exact position.

The scraper blades (2) are oriented in parallel. A parallel orientation is much better for the user to access most, if not all, the area of the surface to be cleaned.

The drawings included with the present disclosure illustrate embodiments of the brush design. The drawings are not meant to be limiting in any sense. As discussed, the multiple layers of securing means essentially ensure that any bristles will break before they are dislodged from their secure mounting, and breakage of the type of bristles used is virtually impossible.

### BRIEF DESCRIPTION OF THE DRAWINGS

FIG. 1A is an exploded perspective view showing the present surface cleaning brush detached from a handle;

FIG. 1B is a perspective view of the present brush secured to a handle; and

FIGS. 2A-2F are detailed perspective views of the sequence used in constructing the present brush.

### DETAILED DESCRIPTION

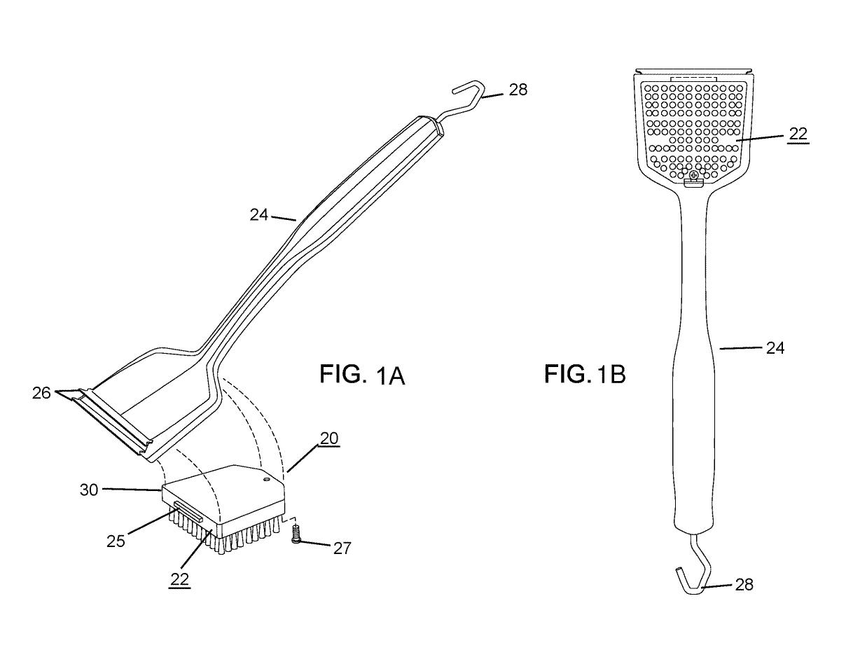

Referring now more specifically to the drawings, and to FIGS. 1A and 1B in particular, numeral 20 designates generally a surface cleaning brush. Brush 20 is configured for use in cleaning the cooking surface of a barbecue grill and, as such, has a brush head portion 22, comprising a block 30 and an elongated handle 24. Brush 20 also includes scraper blades 26, disposed at an outer portion of the brush head, and a swiveling hook 28, disposed at the end of the handle opposite the brush head.

While shown configured for use as a barbecue grill brush, the present surface cleaning brush can be used for a multitude of purposes, and can be supplied with or without a scraper, and/or with or without a hook. Reference will be made herein to a brush for cleaning the cooking surface of a barbecue grill, but only as an example of intended use. The structural components, particularly the brush head, can be used in many different environments and in a variety of cleaning or brushing endeavors.

As can be seen in FIG. 1A, the brush head 22 is detachable from the handle 24. When detached, the brush can be used as a hand-held cleaning brush. The brush head can also be detached in the event a replacement brush head is needed or desired or if a replacement handle is needed or desired. The brush head has a tab 25 which engages a corresponding slot (not shown) in the handle and a screw 27, or similar expedient, is used to secure the brush head to the handle.

The scraper blades 26 are oriented generally perpendicular to the longitudinal axis of the brush head and generally parallel to one another. As opposed to many prior art scraper blades that have a V-shaped orientation, the parallel orientation is found to be more efficient, particularly on a barbecue grill cooking grate. Regardless of the direction of travel, the leading blade loosens or removes debris, while the following blade removes any debris left behind.

Hook 28 is rotationally mounted in the end of handle 24. This facilitates replacing the brush assembly on an existing hook, protrusion, rail, or the like.

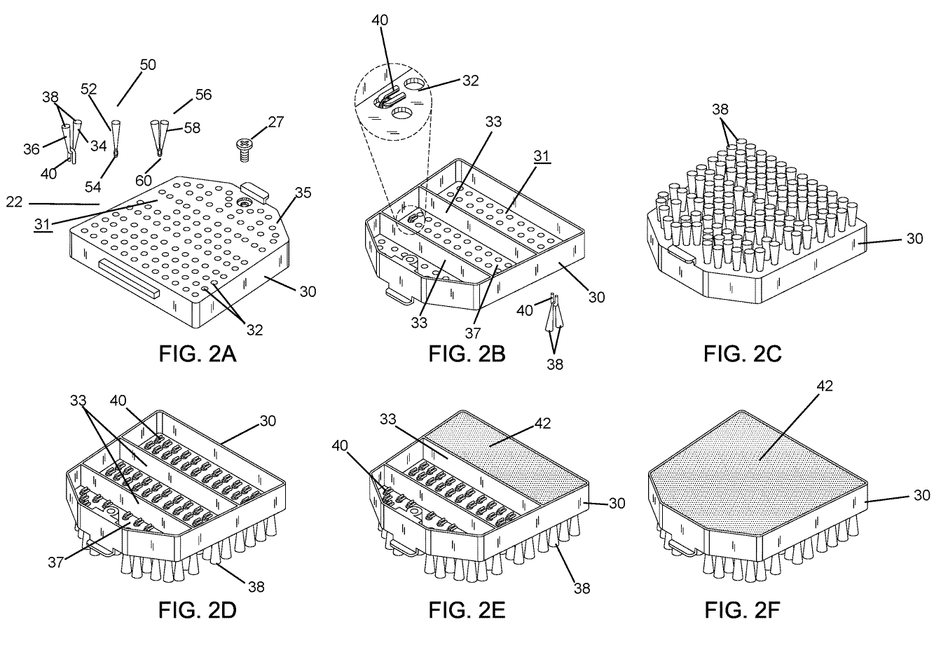

FIGS. 2A-2F illustrate the sequence of assembly for the present surface cleaning brush. As shown, the brush head 22 has a block 30. The block includes a plate 31 having a plurality of apertures 32. The plate has an outer surface 35 which faces the exterior of the block 30 and an inner surface 37 which receives the base of the bristle assemblies and the pins, (described below). Into each aperture, a bristle assembly 34 is inserted. Bristle assembly 34 is generally U-shaped with the base 36 of the U being pushed through the aperture, leaving the outer bristle filaments 38 extending radially outward from the block 30 to form the working surface of the brush head 22. The bristle assembly 34 may be pushed through each aperture 32 either by itself, or along with pin 40, which is generally U-shaped and is engaged with the base 36 of the bristle assembly, as shown in FIG. 2A. In an alternate embodiment, a bristle assembly may have a single bristle or multiple bristles with a base formed as an eyelet. In this embodiment, the eyelet is pushed through the aperture and secured with the pin 40.

The modified bristle assemblies are shown in FIG. 2A. As illustrated, bristle assembly 50 has a single bristle 52 and an eyelet base 54. Bristle assembly 56 has a pair of bristles 58 and an eyelet base 60. Other numbers of bristles are considered to be within the scope of the present disclosure.

The block 30 may include dividing walls 33. The walls are used to stabilize the block 30 and may also serve to subdivide the brush head into different regions. For example, the bristles in the leading end of the brush head, i.e., those furthest from the handle, may be of a different composition from the bristles in the center or trailing end. An embodiment may have a combination of steel and copper bristles, as an example.

As shown in FIG. 2b, the bristle assembly 34 is secured in the block 30 by a securing means, such as pin 40, which is engaged with the base 36 of the U-shaped bristle assembly. The outer ends of the pin 40 are then bent in a direction generally perpendicular to the bristle assembly and the inner surface 37 of plate 31 to prevent the bristle assembly from being pulled out of the block 30.

Following insertion and securement of the plurality of bristle assemblies, as shown in FIGS. 2C-2F, the open upper cavity of the block 30 is filled with a suitable material such as plastic, nylon, silicone, or the like to encase the base of the U-shaped bristle assembly and the pins 40. The filler material 42 can be a liquid substance like epoxy or the like or can be a flowable liquid when heated and which then hardens to secure the bristle assemblies in place, thereby preventing their removal. In an alternate embodiment, the pins can be made to expand after they are inserted, such as by application of heat, for example, to prevent their becoming dislodged.

The brush head assembly thus achieves a level of security heretofore not found in brush implements. Once secured, the bristle assemblies are virtually impossible to remove, thereby preventing their being inadvertently lodged in, for example, food being cooked on a recently-brushed cooking surface.

While an embodiment of a surface cleaning brush, and modifications thereof, have been shown and described in detail herein, various additional changes and modifications may be made without departing from the scope of the present disclosure.

I claim:

1. A surface cleaning brush comprising a block with a plate therein, the plate including a plurality of apertures, a plurality of U-shaped bristle assemblies, each having a base and outwardly extending bristles, each of said bases being journaled in one of said apertures and including a pin disposed through said base of said bristle assemblies and oriented perpendicular to said plate to prevent removal of said bristle assemblies.

2. A surface cleaning brush as defined in claim 1 and including a filler material disposed over said pins and bases of said bristle assemblies.

3. A surface cleaning brush as defined in claim 1 and including a handle attached to said block.

4. A surface cleaning brush as defined in claim 3 and including at least one scraper blade secured to said block.

5. A surface cleaning brush as defined in claim 1 in which said brush includes a handle attached thereto, said handle having a swiveling hook in the end opposite said attachment to said brush.

6. A surface cleaning brush as defined in claim 1 and including at least one scraper blade secured to said block.

7. A surface cleaning brush as defined in claim 6 and including a second scraper blade disposed parallel to said at least one scraper blade.

8. A surface cleaning brush comprising a brush head having a block with a plate formed thereon, said plate having an outer surface and an inner surface and a plurality of apertures formed therethrough, a plurality of U-shaped bristle assemblies disposed in said apertures, said bristle assemblies each having a U-shaped base and outwardly extending bristles, said U-shaped bases being disposed adjacent said inner surface of said plate, and a plurality of pins disposed through said U-shaped bases and oriented perpendicular to said inner surface to prevent removal of said bristle assemblies.

9. A surface cleaning brush as defined in claim 8 and including a filler material disposed over said pins and bases of said bristle assemblies.

10. A surface cleaning brush as defined in claim 8 and including a handle attached to said block.

11. A surface cleaning brush as defined in claim 8 in which said brush includes a handle attached thereto, said handle having a swiveling hook in the end opposite said attachment to said brush.

12. A surface cleaning brush as defined in claim 8 and including at least one scraper blade secured to said block.

13. A surface cleaning brush as defined in claim 12 and including a second scraper blade disposed parallel to said at least one scraper blade.

14. A surface cleaning brush comprising a block with a plate therein, said plate having a plurality of apertures, a plurality of bristle assemblies, each having a base and an outwardly extending bristle, said base being disposed on one side of said plate and said bristle being disposed on the opposite side of said base, whereby said bristle assemblies are disposed in said apertures, and a pin disposed through said base for preventing removal of said bristle assemblies.

15. A surface cleaning brush as defined in claim 14 and including a filler material disposed over said pins and bases of said bristle assemblies.

16. A surface cleaning brush as defined in claim 14 and including a handle attached to said block.

17. A surface cleaning brush as defined in claim 14 in which said brush includes a handle attached thereto, said handle having a swiveling hook in the end opposite said attachment to said brush.

18. A surface cleaning brush as defined in claim 14 and including at least one scraper blade secured to said block.

19. A surface cleaning brush as defined in claim 18 and including a second scraper blade disposed parallel to said at least one scraper blade.
